(19) United States
(12) Patent Application Publication
(10) Pub. No.: US 2025/0196284 A1
(43) Pub. Date: Jun. 19, 2025

(54) HAND-HELD GRINDING MACHINE COMPRISING AN ENERGY STORAGE DEVICE AND A DUST REMOVAL PORT

(71) Applicant: Festool GmbH, Wendlingen (DE)

(72) Inventors: Stefan TULODZIECKI, Neuhausen (DE); Timo KUHLS, Stuttgart (DE); Michael HIGELIN, Köngen (DE)

(73) Assignee: Festool GmbH, Wendlingen (DE)

(21) Appl. No.: 18/847,324

(22) PCT Filed: Mar. 24, 2023
(86) PCT No.: PCT/EP2023/057706

§ 371 Date: Sep. 16, 2024

(30) Foreign Application Priority Data
Mar. 25, 2022 (DE) 10 2022 107 172.3

(51) Int. Cl. B24B 23/03; B24B 47/12; B24B 55/10

(52) U.S. Cl. CPC B24B 23/03; B24B 47/12; B24B 55/102

(57) ABSTRACT

A hand-held grinding machine includes a disc tool having a machining face for machining a workpiece; a motor for driving a holder holding the tool arranged in a machine housing; a port for removing dust during machining; and an energy-storage-device interface for detachably connecting, using a connection interface, an energy storage device for supplying electrical energy to the grinding machine that includes an energy-storage-device housing extending along an energy-storage-device longitudinal central plane; and a handle for grasping and guiding the grinding machine forwards along the workpiece in a working direction parallel to a machine longitudinal central plane of the machine housing extending transversely to the machining face. The energy-storage-device interface is arranged relative to the machine plane and/or the connection interface is arranged relative to the energy-storage-device plane such that the energy-storage-device plane is distanced transversely from the machine plane when the device is on the energy-storage-device interface.

The invention relates to a hand-held grinding machine, which has a disk tool having a machining face for machining a workpiece, a machine housing, in which a drive motor for driving a tool holder is arranged, on which holder the disk tool is arranged, a dust discharge connector for conducting away dust that results from the machining of the workpiece by the disk tool, and an energy storage device interface for detachably connecting an electrical energy storage device for supplying electrical energy to the hand-held grinding machine, in particular to the drive motor, using a connector interface of the energy storage device, wherein the electrical energy storage device has an energy storage device housing that extends along a longitudinal center plane of the energy storage device, which plane runs transversely, in particular at a right angle to the machining face, wherein the hand-held grinding machine has a handle portion at which the hand-held grinding machine can be grasped by an operator and guided forward in a working direction, parallel to the longitudinal center plane of the machine, along the workpiece.

Such a hand-held grinding machine is explained, for example, in DE 10 2018 103 767 A1. The hand-held grinding machine has a drive motor arranged in a drive portion of a machine housing, for driving a disk tool. Close to the disk tool, a dust discharge connector is arranged on the drive portion, through which connector dust-laden air charged with particles can be conducted away from the hand-held grinding machine, for example using a suction hose. A handle portion projects away from the drive portion, on which handle portion an energy storage device interface for connecting an energy storage device, namely a rechargeable battery pack, is arranged.

A grinding device provided with a power cable, which could also have an energy storage device interface, is evident from US 2021/0316417 A1.

A grinding device having two energy storage device interfaces is explained in DE 10 2017 125 168 A1.

However, the center of gravity that occurs is not always advantageous and/or the ergonomics of the handle portion that occur are not advantageous for all operating situations.

It is therefore the task of the present invention to make available an improved hand-held grinding machine.

To accomplish this task, it is provided, in the case of a hand-held grinding machine of the type stated initially, that the energy storage device interface of the hand-held grinding machine, with reference to the longitudinal center plane of the machine and/or the connection interface of the energy storage device is arranged, with reference to the energy storage device longitudinal center plane, in such a manner that the energy storage device longitudinal center plane has a transverse distance from the machine longitudinal center plane when the energy storage device is held on the energy storage device interface.

It is possible that the connection interface of the energy storage device is arranged asymmetrically with reference to the energy storage device longitudinal center plane, while the energy storage device interface of the hand-held grinding machine has a transverse distance or lateral offset relative to the machine longitudinal center plane. It is also possible, however, that the hand-held grinding machine has an energy storage device interface that is arranged symmetrically with reference to its machine longitudinal center plane, and the connection interface of the energy storage device is arranged asymmetrically with reference to the energy storage device longitudinal center plane and/or has a transverse distance from the energy storage device longitudinal center plane, so that the longitudinal center plane of the energy storage device does not align with the machine longitudinal center plane when the energy storage device is mounted on the machine housing or the energy storage device interface of the hand-held grinding machine, but rather has a transverse distance from it. Both of the aforementioned measures can also be provided in combination, for example if the energy storage device is supposed to have the greatest possible transverse distance from the machine longitudinal center plane.

It is a basic idea that an asymmetrical configuration is implemented, in which the energy storage device is not arranged as in the case of the hand-held grinding machine explained in DE 10 2018 103 767 A1, for example, which represents a typical hand-held grinding machine, so as to align with the machine housing in the working direction, i.e., that the longitudinal center planes of the machine housing and the energy storage device align with one another, but rather with a lateral offset transverse to the working direction and/or transverse to the machine longitudinal center plane. Consequently, for example with reference to the working direction, with which the hand-held grinding machine can be guided forward along a workpiece, there is room at the side, next to the energy storage device, for example for a handle, the dust discharge connector or similar other components of the hand-held grinding machine.

The embodiment of the hand-held grinding machine explained below is a preferred embodiment of the aforementioned hand-held machine tool, but even in connection with the characteristics mentioned initially or the characteristics of the preamble of claim 1, this is an independent invention.

In the case of this hand-held grinding machine according to the preamble of claim 1 or according to the above explanations, it is provided that an underside of the dust discharge connector, which underside faces the machining face, has a dust discharge connector distance from a plane that contains the machining face, which distance is greater than a minimum energy storage device distance from the plane of an underside of the energy storage device mounted on the energy storage device interface, which underside faces the machining face.

The energy storage device preferably forms a component of the hand-held grinding machine and can be detachably fastened to the machine.

The energy storage device preferably has a maximum of five, in particular a maximum of four, further preferably a maximum of three, and even further preferably a maximum of two or even just one single storage cell in a direction perpendicular to the plane in which the machining face is arranged. For example, the energy storage device only has storage cells that are arranged in a single layer next to one another.

It is also possible, however, that the energy storage device has multiple, for example 2 or 3 layers of storage cells, which are arranged one on top of the other. In this regard, it is possible that the storage cells of storage cell layers arranged one on top of the other have a lateral offset, so that a storage cell of the one storage cell layer engages into an interstice between storage cells of the other storage cell layer. Consequently, it is therefore possible that the energy storage device housing has a flat shape or is flat, and nevertheless the minimum distance of the energy storage device housing from the plane in which the machining face extends is less than the minimum distance of the dust discharge connector.

The machining face is preferably a planar surface. The dust discharge connector distance and the energy storage device distance are therefore, for example, the perpendicular distances from a plane in which the machining face extends. However, it is also possible that the machining face has a curved or arc-shaped form, which extends, however, essentially in the aforementioned plane, to which the energy storage device distance and the dust discharge connector distance are related.

In this regard, it is a fundamental idea that the energy storage device is arranged closer to the disk tool, relatively close to the workpiece to be machined, while the dust discharge connector has a greater distance from the machining face and thereby from the workpiece. An advantage results from the fact that the energy storage device, which is relatively heavy, in practice, brings about an advantageous center of gravity position of the hand-held grinding machine, namely close to the machining face and thereby advantageously close to the workpiece that can be machined by the hand-held grinding machine. A further or another advantage lies in that a suction hose, a dust collection container or the like, for example, has a greater distance from the machining face and thereby also advantageously from the workpiece that can be machined using the hand-held grinding machine. Thus it is thereby possible, for example, that a voluminous dust collection container can be mounted on the dust discharge connector. Also the guidance of a suction hose that can be connected to the dust discharge connector is improved in the configuration of the hand-held grinding machine having the aforementioned distances of the dust discharge connector and the energy storage device from the machining face.

It is preferred if the center of gravity of the energy storage device is arranged close to the machining face and/or in a rear end region, in the working direction, of the disk tool and/or close to the outside circumference of the disk tool.

The dust discharge connector distance and the energy storage device distance are the distances of the dust discharge connector and the energy storage device perpendicular to a plane in which the machining face runs. With reference to this plane or machining face or with reference to the workpiece, when the hand-held grinding machine is being used, the dust discharge connector has a greater distance than the energy storage device. In other words, the dust discharge connector is farther above a surface of the workpiece that can be machined using the hand-held grinding machine than the energy storage device is.

A clear width between a plane, on the one hand, in which the machining face runs or in which the machining face is arranged, at least essentially, for example if the disk tool does not have a completely planar machining face, and, on the other hand, the dust discharge connector, is greater than a clear width between this plane and the energy storage device.

At this point, it should be noted that a longitudinal axis of the dust discharge connector, along which the dust discharge connector extends, and/or a longitudinal axis of the energy storage device, when the latter is mounted on the machine housing, can be parallel to the machining face or inclined at a small angle of less than 5°. However, it is also possible that one of the aforementioned longitudinal axes, the longitudinal axis of the dust discharge connector and/or the longitudinal axis of the energy storage device, can have an incline relative to the machining face, for example an incline of 10-30°. At this point, it then becomes clear that the dust discharge connector and/or the energy storage device can have an incline relative to the machining face, wherein one longitudinal end region of the dust discharge connector or the energy storage device is closer to the machining face and the other longitudinal end region is farther away from the machining face. The region of the dust discharge connector that is situated closer to the machining face then has the smallest dust discharge connector distance, and the region of the energy storage device that is situated closer to the machining face has the smallest energy storage device distance. The smallest dust discharge connector distance is greater than the smallest energy storage device distance.

An advantageous concept provides that the energy storage device interface is arranged asymmetrically with reference to the machine longitudinal center plane and/or is arranged laterally transversely next to the machine longitudinal center plane, entirely or by at least by 80% of its longitudinal expanse that extends transversely to the machine longitudinal center plane. In particular, the energy storage device interface is arranged laterally offset only to one side, transverse to the machine longitudinal center plane, and does not extend or extends only to a slight extent of maximally 20% of its longitudinal expanse that extends transverse to the machine longitudinal center plane to a side that lies opposite the first side. Therefore the energy storage device interface is arranged entirely or almost entirely next to the machine longitudinal center plane, so that the energy storage device, on the one hand, and another component of the hand-held grinding machine, for example the dust discharge connector or a suction hose or dust collection container arranged on the dust discharge connector, on the other hand, can be arranged on opposite sides of the machine longitudinal center plane,.

A preferred variant provides that the energy storage device interface has a first and at least a second energy storage device interface connector for a first and at least a second energy storage device. The energy storage device interface connectors can have the same construction, but can also be different. The energy storage devices that can be mounted on the energy storage device interface connectors can be similar, in other words, for example, have geometrically equivalent energy storage device housings and/or have electrically similar properties. It is also possible, however, that the energy storage devices have different electrical properties, for example different voltages and/or a different electrical energy storage device capacity.

It is advantageous if it is provided that at least one energy storage device, further preferably additional energy storage devices, for example two or three energy storage devices, can be arranged on the energy storage device interface that is arranged asymmetrically with reference to the machine longitudinal center plane. The energy storage device interface can be configured in such a manner that the multiple, for example two energy storage devices can be fastened and/or arranged next to one another on the energy storage device interface, transverse to the machine longitudinal center plane, and/or that multiple, for example also two energy storage devices can be fastened and/or arranged on the energy storage device interface, one behind the other, with reference to an axis that runs parallel to the machine longitudinal center plane or runs at a slight angle of less than 45° relative to the machine longitudinal center plane.

The connection interface of the energy storage device can be arranged, as explained, asymmetrically with reference to the energy storage device housing. Thus, for example, one embodiment provides that the connection interface of the energy storage device, which is provided for being connected to the energy storage device interface of the hand-held grinding machine, has different distances from the longitudinal sides of the energy storage device housing, between which the energy storage device longitudinal center plane runs.

In the case of the hand-held grinding machine, an advantageous arrangement provides that longitudinal sides or longitudinal side walls of an energy storage device housing of the energy storage device extend, in the state of the energy storage device in which it is mounted on the machine housing, parallel to or at a slight angle of less than 40°, preferably less than 35°, in particular less than 30°, particularly preferably less than 20° relative to the machine longitudinal center plane. The longitudinal sides or longitudinal side walls can run parallel to one another. However, it is also possible that the longitudinal sides or longitudinal side walls are at an angle relative to one another, so that the energy storage device housing has a trapezoid shape, for example. In particular, it is advantageous if the longitudinal sides or longitudinal side walls converge in the direction of the connection interface and/or toward the machine housing.

It is advantageous if the longitudinal sides or longitudinal side walls of the energy storage device housing have different distances from the machine longitudinal center plane.

It is advantageous if it is provided that the energy storage device interface forms the only energy storage device interface of the hand-held grinding machine. Consequently, therefore, no further energy storage device interfaces are present.

It is advantageous if only a single energy storage device can be arranged on the energy storage device interface. The energy storage device interface is preferably configured for installation of only a single energy storage device. A further energy storage device, for example to increase the supply voltage and/or the supply current, therefore cannot be detachably arranged on the energy storage device interface in the case of this embodiment.

Furthermore, it is practical if the hand-held grinding machine can be supplied with electrical energy only by means of a single energy storage device. It is therefore not possible to connect a further energy storage device to the hand-held machine tool in the case of this embodiment.

It is true that it is possible that the energy storage device interface is arranged of the handle section or in a free end region of the machine housing of the hand-held grinding machine.

However, a preferred embodiment provides that the energy storage device interface of the hand-held grinding machine is arranged between the tool holder or, if applicable, the disk tool fastened to or held on the tool holder, and a longitudinal end region of the handle section that faces away from the tool holder or the disk tool, respectively. It is possible that the energy storage device held on the energy storage device interface projects beyond the free end region of the machine housing or of the handle section in the case of this embodiment, as well. However, it is also possible that the energy storage device held on the energy storage device interface does not project beyond the free end region of the handle section or the free end region of the machine housing on a side facing away from the tool holder, in the case of this embodiment.

The energy storage device fastened to the energy storage device interface advantageously projects by maximally 50%, in particular maximally 30%, further preferably by maximally 20% of its longitudinal length, which runs parallel to a distance between the tool holder and a longitudinal end region of the handle section or of the machine housing that faces away from the tool holder, beyond the longitudinal end region of the handle section or of the machine housing.

It is advantageous if the energy storage device held on or fastened to the energy storage device interface is arranged with a partial region between the tool holder and the free end region of the machine housing or the free end region of the handle section. This partial region preferably has such a length that at least half, preferably at least two-thirds, even further preferably at least 75% or 80% or 85% of the length of the energy storage device housing is arranged between an end region of the handle section or of the machine housing that faces away from the tool holder and the tool holder when the energy storage device is fastened to the energy storage device interface.

In a variant of the invention, the energy storage device interface can be arranged on a top side of the hand-held grinding machine or a side facing away from the tool holder.

Furthermore, it is possible that the energy storage device interface is arranged on a side, for example on a longitudinal side that extends between an underside or the side having the tool holder and a top side or on the side opposite to the side having the tool holder.

However, placement of the energy storage device interface on an underside or the side of the machine housing or of the handle section or both, which side faces the machining face during use of the hand-held grinding machine, is preferred. A preferred concept provides that the energy storage device interface is arranged on a side of the machine housing that is oriented in the direction of the machining face, in particular of the handle section of the machine housing. It is also advantageous if the energy storage device interface is arranged on a side of the machine housing having the tool holder, in particular in the region of the handle section.

It is advantageous if the energy storage device housing has a front side or a front side wall that faces the machine housing, and a rear side or rear side wall that faces away from the machine housing, which side or wall runs transversely, in each instance, in particular transversely at a right angle to the machine longitudinal center plane. Furthermore, the front side or front side wall and the rear side or rear side wall preferably run parallel to one another.

Furthermore, the energy storage device housing has a top side or top side wall and an underside or underside wall on opposite sides or sides that face away from one another. The top side and underside can run parallel to one another or also have an angle relative to one another, for example of maximally 15°. It is advantageous if the connection interface for the energy storage device interface of the machine housing is provided on the top side or top side wall.

The dust discharge connector and the energy storage device can be arranged on opposite sides of the machine longitudinal center plane or of a plane of the machine housing that is parallel to the machine longitudinal center plane. One embodiment can provide that the energy storage device longitudinal center plane as well as a center plane of the dust discharge connector, which is perpendicular to the machining face or to a plane that contains the machining face, and parallel to the machine longitudinal center plane, are arranged on opposite sides of the machine longitudinal center plane. It is possible that the dust discharge connector and the energy storage device are essentially arranged, with reference to their transverse width, transverse to the machine longitudinal center plane, on opposite sides of the machine longitudinal center plane, but the machine longitudinal center plane passes through the dust discharge connector and/or the energy storage device.

It is advantageous if it is provided that the energy storage device distance in a longitudinal end region of the energy storage device that faces the machine housing of the hand-held grinding machine is smaller than in a longitudinal end region that faces away from the machine housing. Thus, for example, it can be provided that the underside or underside wall has an incline with reference to the machining face. The incline is preferably maximally 30°, in particular maximally 20° or maximally 15°.

The embodiment of the hand-held grinding machine explained below, which also represents an independent invention in connection with the characteristics of claim 1 contained in the preamble, provides that the energy storage device and/or the dust discharge connector do not project transverse to the machine longitudinal center plane or only project by maximally 20%, in each instance, in particular maximally 15%, in each instance, preferably maximally 10%, in each instance, of a transverse width that extends transverse to the machine longitudinal center plane, beyond an outside contour of the disk tool. The energy storage device or its energy storage device housing and/or the dust discharge connector are arranged within a corridor that extends parallel to the machine longitudinal center plane, and the lateral delimitations of which is defined by the maximum transverse distance of the disk tool relative to the machine longitudinal center plane. This disk tool is preferably the narrowest disk tool, with reference to the machine longitudinal center plane, that can be detachably fastened to the hand-held grinding machine.

Now it is fundamentally possible that the dust discharge connector projects beyond the machine housing or a cover for the disk tool, in the direction of the disk tool, in particular to the rear in the working direction. Preferably, however, the dust discharge connector is arranged as close as possible to the machine longitudinal center plane. It can be advantageously provided, for example, that the dust discharge connector does not project transverse to the longitudinal center plane, beyond an outside circumference contour of the machine housing or a cover arranged on the machine housing, in particular a suction hood for the disk tool. The disk tool projects beyond the cover, for example, transverse to the machine longitudinal center plane.

It is advantageous if it is provided that the disk tool is arranged in a suction space connected to the dust discharge channel in terms of flow. The suction space is arranged on a suction hood, for example, or formed by this hood.

An advantageous embodiment provides that the dust discharge connector is arranged on a suction hood that covers the disk tool, at least in part.

However, it is also possible that the suction space in which the disk tool is arranged communicates with a dust discharge channel that runs through the machine housing.

It is advantageous if a dust discharge channel that communicates with the dust discharge connector runs through the machine housing. In this embodiment it is possible, for example, that dust that occurs at the machining face can flow out of the suction space, through the machine housing, to the dust discharge connector.

For example, the dust discharge channel that runs through the machine housing makes implementation of the following configuration possible in a simple manner.

It is advantageous if it is provided, in the hand-held grinding machine, that a top side of the dust discharge connector, which side faces away from the machining face, is arranged entirely or in part above a top side of the energy storage device arranged on the energy storage device interface, which top side faces away from the machining face.

A preferred embodiment of the hand-held grinding machine provides that it has a dust discharge channel that communicates with a suction space in which the disk tool is arranged and with the dust discharge connector and/or produces a flow connection between the dust discharge connector and the suction space. The dust discharge channel is arranged on or in the machine housing, for example, or runs through the machine housing.

It is advantageous if it is provided that the dust discharge channel runs past the energy storage device interface.

It is advantageous if the dust discharge connector has a connecting piece for connecting a suction hose or dust collection container, or is formed by such a piece. It is possible that holding contours, for example shape-fit contours, in particular bayonet contours, engagement contours or the like, for fixing the suction hose or dust collection container in place, can also be arranged on the dust discharge connector.

The dust collection container can form a component of the hand-held grinding machine. It is advantageous if the dust collection container is arranged within a corridor, the outside of which is defined by the transverse width of the disk tool transverse to the machine longitudinal center plane. The dust collection container can preferably be detachably fastened to the dust discharge connector.

It is advantageous if it is provided that the dust discharge connector defines a flow channel that extends along a longitudinal expanse axis that is parallel to the machine longitudinal center plane or has an angle of maximally 30°, in particular maximally 20°, particularly preferably maximally 15° or maximally 10° relative to the machine longitudinal center plane. Specifically if the longitudinal expanse axis of the dust discharge connector runs parallel to or, only at a slight angle, with a slant relative to the machine longitudinal center plane, a suction hose connected to the dust discharge connector, for example, in particular the connecting piece, can be arranged very close to the machine longitudinal center plane or run close to it. Thereby, for example, the suction hose is arranged within a corridor at its end region that is connected to the hand-held grinding machine, the outer sides of which corridor is defined by the transverse width of the disk tool transverse to the machine longitudinal center plane.

It is advantageous if it is provided that the machine longitudinal center plane passes through the handle section and/or that the handle section projects beyond the machine longitudinal center plane from opposite sides.

The handle section, in particular a handle of the handle section, is preferably symmetrical to the machine longitudinal center plane.

It is advantageous if the handle section runs parallel to the machine longitudinal center plane.

It is advantageous if it is provided that the machine housing has a drive portion having a motor housing, which has a motor-accommodating space in which the drive motor is accommodated, wherein the motor housing has a single-piece peripheral wall that surrounds the motor-accommodating space in a ring shape.

The peripheral wall is configured, for example, in the manner of a cylindrical peripheral wall. The motor-accommodating space has the form, for example, of a cylinder that is delimited on the circumference by the peripheral wall. It is preferred if the peripheral wall has a circular inner contour. However, it is also possible that the motor-accommodating space has a different cross-sectional geometry, for example a polygonal cross-sectional geometry or one having at least one corner. In particular, it is advantageous if at least one anti-rotation contour is provided in the motor-accommodating space, to hold the drive motor so as to prevent it from rotating, which contour, for example, by a non-round cross-section of the motor-accommodating space or also by a protrusion that projects into the motor-accommodating space, in particular a rib, or by a shape-fit receptacle into which a contour of the drive motor engages or can engage.

The motor housing ensures protection of the drive motor and furthermore contributes to the rigidity of the machine housing. To provide electricity, a power cable regularly serves for connecting to an electrical energy supply network.

An advantageous measure provides that a connection protrusion that extends along a longitudinal machine axis of the machine housing is arranged on the peripheral wall, on which connection protrusion an energy storage device interface for detachably connecting an electrical energy storage device to supply electrical energy to the hand-held grinding machine is arranged. The peripheral wall is therefore a peripheral wall that is continuous and/or consists of a single body or is formed by a single body. The peripheral wall is not formed by joining together two housing halves or half-shells, but rather is a one-piece component. Other parts of the machine housing can, however, be produced from housing parts, i.e., for example, joined to the peripheral wall or to the basic body or a basic body that has the peripheral wall. The one-piece peripheral wall advantageously gives the motor-accommodating space rigidity and strength.

The peripheral wall is made of plastic, for example.

In total, it is advantageous if the machine housing consists entirely or partially of plastic.

The connection protrusion is in one piece with the machine housing, for example. However, it would also easily be conceivable that the connection protrusion is firmly connected to the machine housing, for example connected with shape fit, in particular screwed onto the machine housing and/or plugged into it and/or connected to the machine housing with material fit, for example glued onto and/or welded onto the machine housing.

In this regard, it is a fundamental idea that the the motor housing protects the drive motor with its peripheral wall, but at the same time an energy storage device interface for connecting an electrical energy storage device, for example a rechargeable battery pack, is present. As compared to a simple network interface or a connecting cable to supply electrical energy by way of a power supply network, the energy storage device interface for connecting an energy storage device or rechargeable battery pack is larger, and for this reason a machine housing is typically provided in the case of hand-held grinding machines, which housing has half-shells or housing parts between which the energy storage device interface is held.

A preferred concept provides that the hand-held grinding machine has a handle section at which the hand-held grinding machine can be grasped by an operator and guided in a working direction, in particular parallel to or with a directional component parallel to the machine longitudinal axis of the machine housing, forward along the workpiece, wherein the connection protrusion and/or at least a part of the handle section project(s) to the back, in the working direction, away from the motor housing. Thereby the hand-held grinding machine can be operated comfortably.

It is advantageous if the handle section is arranged on a handle body arranged on the machine housing, in particular at least partially in one piece with the machine housing, which body projects to the back, in the working direction, away from the motor housing. The handle body can be in one piece or in multiple parts. It is preferred if the handle body comprises a housing body that is in one piece with the machine housing or firmly connected to it, as a handle body part that is connected to or closed off by a housing lid as another handle body part.

The connection protrusion having the energy storage device interface can interact with the handle body. For example, the handle body is supported by the connection protrusion. However, it is also possible that the connection protrusion forms the handle body, in whole or in part. For example, an arrangement is possible, in which the connection protrusion can be grasped by the operator, but in addition, a handle body is also provided, to be grasped by the operator.

An advantageous concept provides that the handle body and the connection protrusion are directly connected to one another in an end region that faces away from the motor housing. For the other end region of the handle body and the connection protrusion, it is advantageous if a connection is also provided. It is preferred if the handle body and the connection protrusion are connected to one another in the region of the motor housing, by means of the motor housing. However, it is also possible that the connection protrusion and the handle body are directly connected to one another, at the machine housing. This measure can advantageously contribute to the rigidity of the machine housing and/or hand-held grinding machine.

The following measures are ergonomically advantageous; they can also represent, for example, protection for a hand of an operator guiding the hand-held grinding machine. Furthermore, the measures explained below also ensure great rigidity of the machine housing, so that, for example if it falls onto a surface, no or little damage would be expected.

A preferred concept provides that a reach-through opening is provided between the handle body and the connection protrusion, through which opening a hand of an operator holding the handle body can reach.

It is advantageous if the handle body and the connection protrusion have or form an approximately V-shaped or U-shaped form, in total, transverse to the machine longitudinal axis. For example, the handle body and the connection protrusion form side legs of the V-shaped or U-shaped configuration, which legs are connected to one another, at their end region that is at a distance from the machine housing and/or motor housing, directly in the case of the V-shaped configuration and by means of a base leg in the case of the U-shaped configuration.

The handle body and/or the connection protrusion preferably have an elongated shape.

It is advantageous if a longitudinal axis of the handle body is oriented approximately parallel or at a slight angle with reference to the machining face.

A longitudinal axis of the connection protrusion is preferably at an angle to the machining face, for example at an angle of maximally 30° and/or a greater angle with reference to the machining face than the longitudinal axis of the handle body.

An advantageous concept provides that the handle body and the connection protrusion have wall sections that lie opposite one another, which sections extend transverse to the machine longitudinal axis or transverse to the longitudinal center plane of the machine, which plane runs parallel to the machine longitudinal axis and is at an angle to the machining face, in particular at a right angle. Furthermore, it is possible that the handle body and the connection protrusion have wall sections having a lateral offset from one another.

It is advantageous, in this regard, if a transverse width of the wall section of the connection protrusion amounts to at least 80%, preferably at least 90%, of the transverse width of the wall section of the handle body in the region of the machine housing. Consequently the connection protrusion transverse to the machine longitudinal axis is relatively wide.

One embodiment can provide that the energy storage device interface forms an integral component of the connection protrusion or is in one piece with the connection protrusion, at least in part. However, a modular concept is preferred.

An advantageous variant provides that the energy storage device interface has an energy storage device holding body, separate from the connection protrusion, for shape-fit holding of the energy storage device, wherein the energy storage device holding body is accommodated in a holding body holder arranged on the connection protrusion. The energy storage device holding body has connection means, for example shape-fit contours, in particular longitudinal grooves, engagement contours or the like, and/or electrical connection contacts for producing electrical connections between the energy storage device and electrical components arranged in the machine housing of the hand-held grinding machine.

The energy storage device holding body can be plugged into the holding body holder, for example. The holding body holder is configured, for example, as a plug-in socket.

A preferred concept provides that the holding body holder is closed off by means of a holder closure body, which is detachably connected or can be connected with the connection protrusion, in particular screwed into it. It is advantageous if the holder closure body is configured as a housing part. However, it is also possible that the holder closure body is, for example, a screw, a plug-in element or the like.

It is advantageous if the holder closure body is joined onto the connection protrusion with a joining direction transverse to the machine longitudinal axis and/or if a support region of the holder closure body, with which the holder closure body is supported on the connection protrusion, has a greater longitudinal expanse with a direction component parallel to the machine longitudinal axis than transverse, in particular transverse at a right angle, to the machine longitudinal axis. The support region comprises, for example, opposite wall sections or end faces of walls of the holder closure body. Consequently, the holder closure body is configured as an elongated closure body that essentially extends along the machine longitudinal axis. These measures can advantageously contribute to effective support of the energy storage device on the motor housing or on the machine housing, respectively.

The holder closure body and the connection protrusion are structured, for example, as housing parts or housing shells.

It is advantageous if the holder closure body is held on the connection protrusion by means of plug-in contours.

The plug-in contours can contribute to the fact that the weight forces of the energy storage device that engage on the energy storage device interface are optimally introduced into the machine housing.

A preferred concept provides that a plug-in arrangement having at least a plug-in protrusion and a plug-in socket that holds the plug-in protrusion are arranged on the holder closure body and the connection protrusion, and engage into one another in the state when the holder closure body is mounted on the connection protrusion and/or are supported on one another in the sense of centering of the holder closure body on the connection protrusion, to center them.

The plug-in arrangement preferably comprises a serial arrangement of multiple plug-in protrusions and plug-in sockets, which are in engagement with one another in the state when the holder closure body is mounted on the connection protrusion.

It is furthermore advantageous if at least one plug-in socket of the plug-in arrangement is formed by wall sections that are at a distance from one another, one wall section of which lies opposite the energy storage device holding body, in particular to support it, and the other wall section forms an outer wall of the connection protrusion. The wall sections run, for example, transverse to the longitudinal center plane of the machine. The plug-in socket is formed directly by wall sections and provided in a cavity between the wall sections.

An advantageous embodiment provides that at least one plug-in socket of the plug-in arrangement is formed by a step or holding groove into which a plug-in protrusion engages, wherein the step or holding groove as well as the plug-in protrusion are arranged on end faces of walls of the connection protrusion and of the holder closure body, which end faces engage into one another and/or are supported on one another.

It is possible, for example, that a step or groove is provided on one of the walls into which the end face of the other of the walls engages, on end faces of walls of the holder closure body and of the connection protrusion, which end faces lie against one another or engage into one another.

It is advantageous if it is provided that the energy storage device interface supports the energy storage device as optimally as possible. In the following, some advantageous measures for this purpose are proposed.

An advantageous concept provides that the energy storage device interface, in particular the energy storage device holding body, has an elongated shape and extends along the connection protrusion. In particular, it is advantageous if the energy storage device interface extends in the direction of the machine longitudinal axis, along the connection protrusion.

The energy storage device interface, in particular the energy storage device holding body, preferably has a plug-in socket for plugging in the energy storage device or is configured as such a socket.

Preferably, it is provided that the the energy storage device interface, in particular the energy storage device holding body, has shape-fit contours that extend along its longitudinal expanse, in particular longitudinal grooves and/or longitudinal protrusions. It is furthermore advantageous if engagement means are present in the energy storage device interface, to lock the energy storage device in place. The engagement means comprise, for example, one or more engagement sockets.

It is advantageous, as explained, if the energy storage device interface and the connection interface of the energy storage device comprise connection contacts, in particular plug-in contacts, to produce electrical connections between the energy storage device and the electrical components of the hand-held grinding machine.

A preferred concept provides that the energy storage device interface, in particular the energy storage device holding body, has connection contacts for the energy storage device that are arranged closer to the motor housing and farther away from the motor housing, in particular arranged in its longitudinal end region that is farthest away from the motor housing, for example data contacts in one longitudinal end region and energy supply contacts at the other longitudinal end region.

The energy storage device preferably projects only a little or to a slight extent beyond the connection protrusion or handle body when it is attached to the machine housing. It is advantageous if it is provided that the energy storage device, when it is arranged on the energy storage device interface, does not project or projects by a maximum of 20%, in particular a maximum of 10%, preferably a maximum of 5% of its longitudinal expanse length beyond a longitudinal end of the connection protrusion and/or of the handle body that faces away from the motor housing. In the rear, in the working direction, the energy storage device projects only to a slight extent or does not project at all beyond the components of the machine housing, for example the hook body and or connection protrusion.

With reference to the machine longitudinal axis, the connection protrusion can run in a straight line, but can also have at least one steps, rounded region or the like. It is preferred if the wall section of the connection protrusion that extends along the machine longitudinal axis has at least one step transverse to the machine longitudinal axis. The at least one step can be provided, for example, in the region of the passage opening, in particular on the passage opening and/or in particular, for widening of the passage opening. However, it is also possible that a step is present on a side of the connection protrusion that faces away from the handle section or handle body. The at least one step contributes, for example, to increasing the size of the passage opening and/or to mechanical reinforcement of the connection protrusion. Part of the at least one step can also be provided, without problems, on the holder closure body, which is configured, in particular, as a housing part.

For optimal protection of the drive motor in the motor housing and/or for easier installation of the drive motor on or in the machine housing, the measures explained below make an advantageous contribution.

It is advantageous if the motor housing has a cover wall that closes off the motor-accommodating space at the end face, in particular one that is in one piece with the peripheral wall. Consequently the motor housing and/or the motor-accommodating space is/are configured, for example, as a plug-in socket into which the drive motor can be plugged.

It is advantageous if the cover wall forms a bottom of the motor-accommodating space.

It is advantageous that the cover wall can have one or more passage openings, for example for cables or similar electrical components, in particular for connecting the drive motor.

It is advantageous if an installation opening is arranged opposite the cover wall, which opening can be closed off by means of the lid that will be explained below.

A preferred concept provides that the motor-accommodating space is exclusively accessible through the installation opening for installation of the drive motor. Additional components, for example an eccentric gear mechanism and/or a fan wheel and/or a tool shaft or the like, can also be arranged on the drive motor, and can also be introduced into the motor-accommodating space through the installation opening. In particular, a drive train that comprises the drive motor, preferably including the tool holder for the disk tool, can be introduced entirely or as a whole through the installation opening into the motor-accommodating space. The drive train comprises, for example, in addition to the drive motor, at least one further drive component, for example a gear mechanism and/or a tool shaft and/or a fan wheel and/or the tool holder. A plug-in cross-section of the installation opening is preferably dimensioned in such a manner that the greatest outside circumference of the drive motor, in particular of the drive train that comprises the drive motor, can be introduced through the installation opening into the motor-accommodating space.

It is advantageous if a plug-in cross-section of the installation opening is dimensioned in such a manner that the drive motor and all the components connected to the drive motor, which components can be connected to the drive motor or mounted on the drive motor only outside of the motor-accommodating space, can be introduced into the motor-accommodating space through the installation opening. For example, joining directions or installation directions can be provided in such a manner that the components connected to the drive motor can be connected to the drive motor only when the drive motor is arranged outside of the motor-accommodating space.

Fastening means, for example screws, can only be accessible for assembly onto the drive motor or a component connected to the drive motor, for example, when the drive motor is arranged outside of the motor-accommodating space.

The installation opening is preferably arranged on the side of the machine housing on which the tool holder is arranged.

However, the installation opening can also be arranged on the side of the machine housing that lies opposite the tool holder.

It can be provided that the motor-accommodating space advantageously has a bottom, wherein this bottom can also be penetrated only by the tool holder. Consequently, a construction is therefore possible, in which the peripheral wall that delimits the motor-accommodating space has a bottom wall through which the tool holder projects beyond the motor-accommodating space, and that an installation opening is provided opposite this bottom wall, through which opening the drive motor, in particular a drive train that comprises the drive motor and can also comprise, for example, a fan wheel, an eccentric weight or the like, can be introduced into the motor-accommodating space. It is advantageous if a lid is provided opposite the bottom wall, with which lid the installation opening can be closed off. The lid can be arranged, for example, on a side of the machine housing that lies opposite the tool holder. The lid can form a handle or a handle part.

On the peripheral wall and/or the cover wall, reinforcing ribs or similar other reinforcement contours can be provided.

The motor-accommodating space can be configured as a plug-in socket for plugging in the drive motor, or can have a plug-in socket or form a plug-in socket.

It is preferably provided that the motor-accommodating space is closed off or can be closed off by means of a lid that can be releasably connected to the motor housing. Thereby, for example, the drive motor can be inserted into the motor-accommodating space that is closed off by means of the lid. The lid can tightly close off the motor-accommodating space. The lid can be provided and configured for fixing the drive motor in place in the motor-accommodating space.

It is possible that a lid is provided in a dedicated manner for closing off the motor-accommodating space, which lid is different from a cover or suction hood for the disk tool. It is preferred, however, if the lid is formed by a cover and/or a suction hood for the disk tool.

The lid is screwed onto, for example, a basic housing body of the machine housing, on which the motor-accommodating space is provided.

The following embodiment of the hand-held grinding machine, for example, can contribute to supporting the aforementioned lid.

It is advantageous if a support wall, in particular a collar-like and/or flange-like support wall and/or a support wall that is in one piece with the peripheral wall, projects away outward on a side of the peripheral wall of the motor housing that faces away from the motor-accommodating space.

The support wall advantageously contributes to reinforcement of the motor housing, among other things.

The support wall can also serve for supporting the handle body or the connection protrusion.

It is preferably provided that the connection protrusion, in particular a section that lies opposite the handle body and/or a section at a distance from the handle body and/or a section of the connection protrusion arranged at a distance from the handle body, is supported on the support wall and/or is in one piece with the support wall.

The machine housing is preferably structured in multiple parts and/or has multiple housing components, for example a basic housing body and/or a housing lid.

A preferred concept provides that the machine housing has a basic housing body that comprises the motor housing and the connection protrusion, advantageously furthermore the handle body, in one piece, wherein the basic housing body is closed off or can be closed off by means of a housing lid. The housing lid can, for example, form a top side of the machine housing that faces away from the disk tool.

Preferably it is provided that the housing lid extends over the entire or essentially the entire machine longitudinal axis of the machine housing, in particular of the basic housing body.

The housing lid advantageously forms a component of the handle section, in particular of the handle body.

For example, the housing lid is arranged on a side of the basic housing body that faces away from the connection protrusion.

It is advantageous if the housing lid and the connection protrusion are arranged on opposite sides of the handle body and/or that the connection protrusion is arranged closer to the disk tool than the housing lid is.

An advantageous concept provides that the housing lid covers the motor housing on a side of the machine housing facing away from the disk tool, in particular completely. It is possible that the housing lid forms the end-face cover wall of the motor housing that has already been mentioned. However, it is also possible that the housing lid represents a component separate from this cover wall.

It is advantageously provided that the housing lid closes off an accommodation space, for example for a controller, in particular a controller module, of the hand-held grinding machine. In the accommodation space, however, also electrical cables or similar electrical components, for example, can be arranged, for example to supply electrical current to the drive motor. It is not compulsory for a controller module to be arranged in the accommodation space.

It is preferred if the housing lid lies opposite the cover wall that closes off the motor-accommodating space. Between the cover wall and the housing lid, for example, the aforementioned accommodation space is formed. Consequently, in the case of this embodiment of the cover wall, which already closes off the motor-accommodating space, in any case, a further lid, namely the housing lid, lies opposite.

It is advantageous if this accommodation space has at least one connection channel for holding electrical lines with which the controller or the controller module and/or the drive motor is connected to or can be connected to the energy storage device interface. The accommodation space is also suitable for laying or holding electrical lines.

A preferred concept provides that at least one switching element, preferably all the switching elements for switching functions that can be influenced by the controller and/or electrical functions of the hand-held grinding machine is arranged in the accommodation space. It can be provided that at least one switching element is arranged on a circuit board or a controller module of the controller. When the controller module is introduced into the accommodation space, as a result the switching element is arranged in the accommodation space at the same time.

The housing lid and/or the basic housing body preferably has/have at least one passage opening for at least one switching element or for an operating body for activation of the switching element, so that the switching element, which is entirely or partially arranged in the accommodation space, can be operated from an outer side of the machine housing.

The multi-part construction of the machine housing makes it possible, in a particularly simple manner, to use different materials or material combinations.

An advantageous concept provides that the basic housing body consists of a harder material than the housing lid. For example, different plastics are used.

It is furthermore advantageous if the housing lid has at least one elastic or soft or shock-absorbing component on its outer side that faces away from the basic housing body. In particular, it is advantageous if the basic housing body does not have any such shock-absorbing or soft component, but rather only the housing lid does.

Furthermore, it can advantageously be provided that the basic housing body consists of fewer materials than the housing lid does, in particular that the basic housing body consists of only a single material. This material is, for example, a hard plastic material.

The housing lid and the holder closure body preferably do not have any direct touch contact. The housing lid and the holder closure body are arranged on the basic housing body, but are connected to one another not in direct contact with one another, but rather by way of the basic housing body. This measure contributes, for example, to rigidity of the machine housing and/or reduces the influence of production tolerances.

The disk tool preferably has a plate-shaped basic body, on which an abrasive material is firmly or detachably arranged. For example, an adhesion agent, for example a hook and loop closure layer, is provided on the machining face for detachably fastening an abrasive disk in place. However, it is also possible that the basic body of the disk tool integrally has a structure suitable for abrasive machining of a workpiece on the machining face. The disk tool can be, for example, a round disk tool, but also a polygonal one, in particular a rectangular or triangular disk tool.

A preferred concept provides that different disk tools can optionally be fastened to the hand-held grinding machine. For attachment to the tool holder of the hand-held grinding machine, the disk tool preferably has a fastening interface on a machine side, for example a screw contour, pass-through openings, or the like, wherein the machine side and the machining face are arranged on opposite sides of the disk tool.

Preferably, flow-through channels are provided on the disk tool, to allow air charged with dust to flow through, wherein the flow-through channels have inflow openings on the machining face and outflow openings on a machine side of the disk tool opposite to the machining face.

A symmetrical embodiment and/or a symmetrical placement of a drive train of the hand-held grinding machine with reference to the machine longitudinal center plane is/are geometrically advantageous.

It is advantageous if it is provided that the machine longitudinal center plane runs parallel to a tool axis of a tool shaft that is driven or can be driven by the drive motor, on which shaft the disk tool is arranged or can be arranged to be driven by the drive motor.

It is furthermore advantageous if a power take-off of the drive motor or a power take-off shaft of the drive motor is arranged in the machine longitudinal center plane.

It is furthermore preferred if a drive and/or a power take-off of a gear mechanism that is arranged between the tool holder and the drive motor extends in the machine longitudinal center plane.

An advantageous concept provides that the disk tool can be driven, with reference to the tool axis, by means of the drive motor, in particular using a gear mechanism, to rotate and/or to oscillate and/or with a hypercycloid rotational movement.

The tool holder of the hand-held grinding machine, to which the disk tool is fastened or can detachably be fastened, can preferably rotate about a tool axis.

It is also possible that a gear mechanism is arranged between the drive motor and the tool holder, by means of which mechanism the tool holder can be driven to perform a hypercycloid and/or eccentric and/or slash or oscillating movement, by means of the drive motor.

The tool axis preferably runs transverse, in particular transverse at a right angle, to the machining face.

The energy storage device contains storage cells, for example battery cells, that can make electrical energy available and are rechargeable.

The energy storage device housing preferably has a cubic shape. The storage cells are arranged in the energy storage device housing.

In the following, an exemplary embodiment of the invention will be explained using the drawing. The figures show:

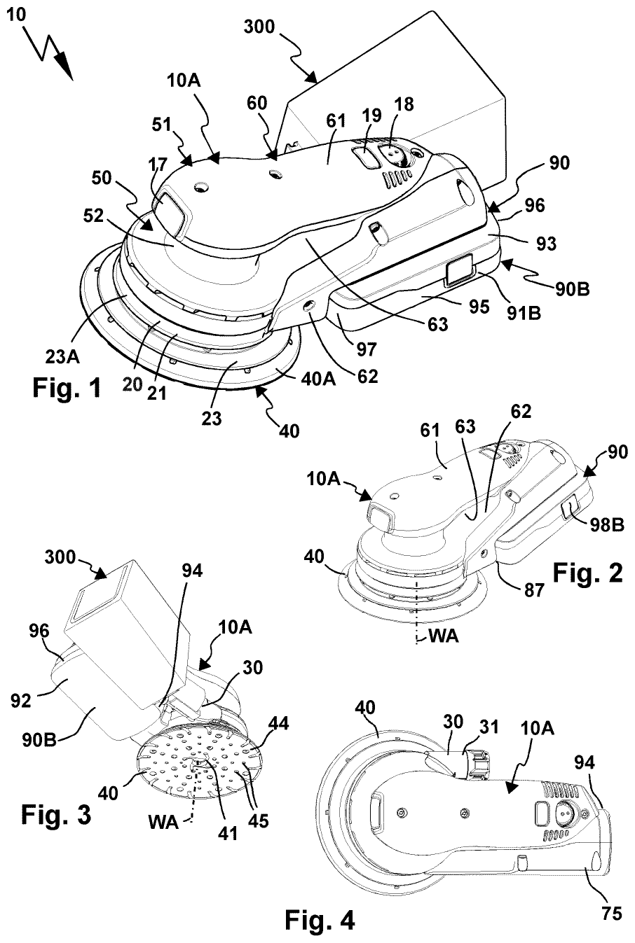

FIG. 1 a perspective slanted view of a hand-held grinding machine at a slant from above, having a dust collection container and a round disk tool,

FIG. 2 the hand-held grinding machine according to FIG. 1, but without a dust collection container,

FIG. 3 the hand-held grinding machine according to FIGS. 1, 2 at a slant from below and from the rear,

FIG. 4 the hand-held grinding machine according to the above figures from above,

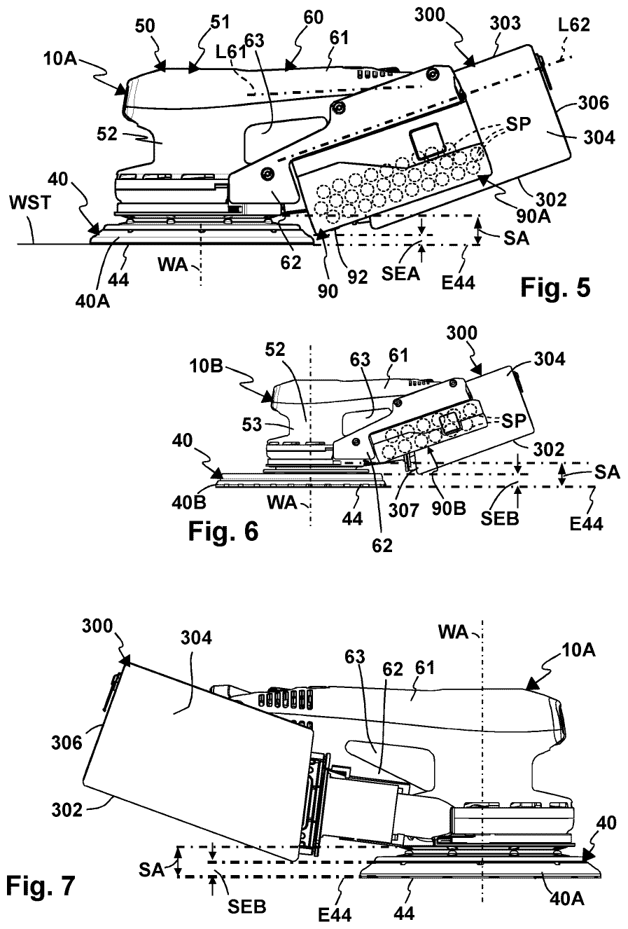

FIG. 5 a side view of the hand-held grinding machine according to FIGS. 1 to 4, having a first energy storage device,

FIG. 6 the hand-held grinding machine according to FIG. 5 in a side view, but with a second, smaller energy storage device,

FIG. 7 the hand-held grinding machine according to FIGS. 5 and 6 in a side view, from the opposite side as compared with the view of FIGS. 5 and 6,

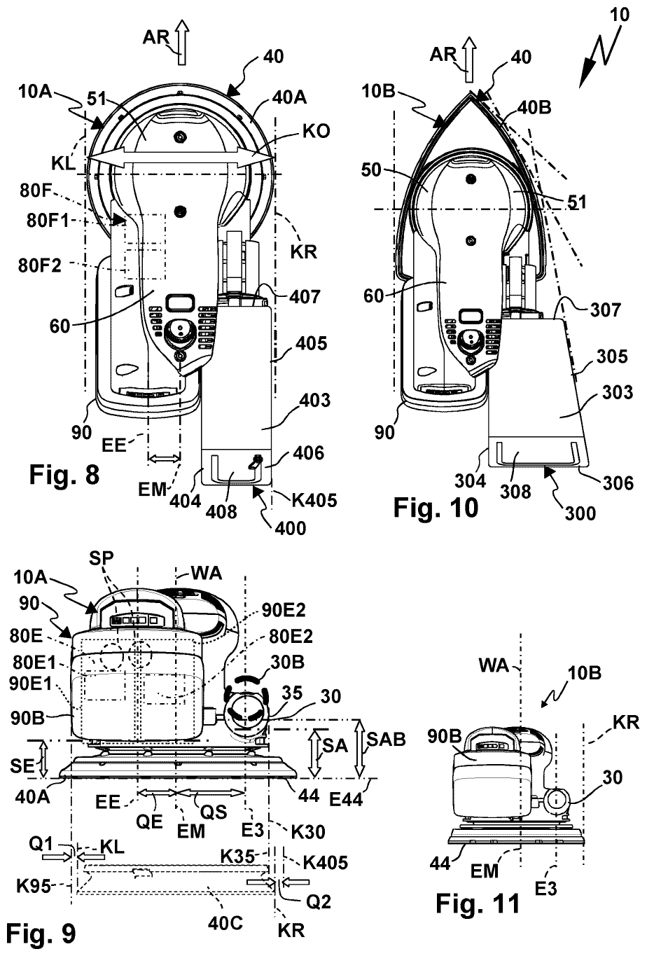

FIG. 8 a view from above onto the hand-held grinding machine according to the above figures, from above, having a first dust collection container,

FIG. 9 the hand-held grinding machine from FIG. 8 from the rear,

FIG. 10 a view from above, approximately according to FIG. 8, of a variant of the hand-held grinding machine according to the above figures, having a polygonal disk tool as well as a second dust collection container,

FIG. 11 the hand-held grinding machine from FIG. 10, from the rear,

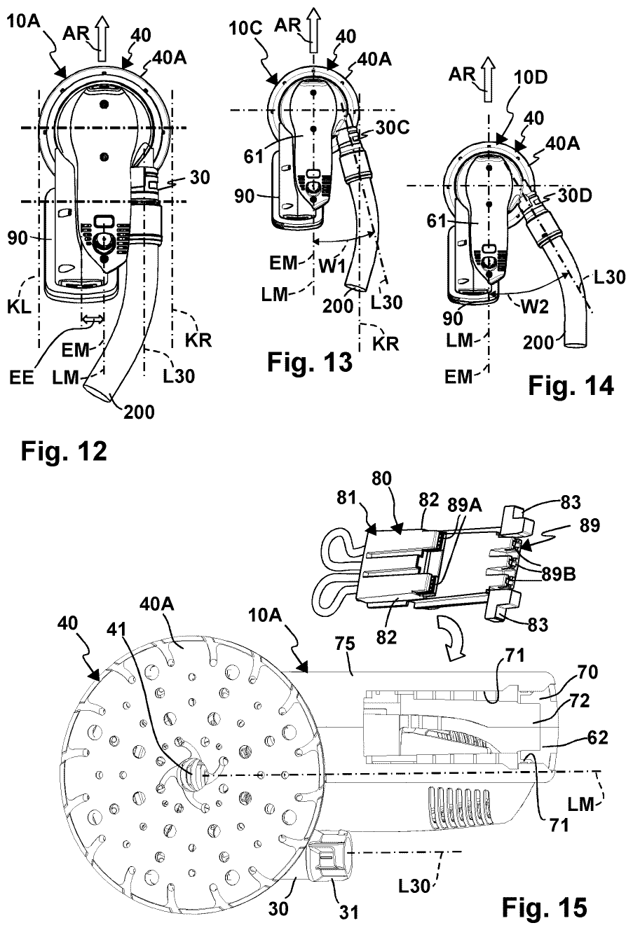

FIG. 12 the hand-held grinding machine of FIGS. 4 and 9, with the round disk tool, in a view from above, with a suction hose,

FIG. 13 a variant of the hand-held grinding machine according to FIG. 12, in a view from above, having a dust discharge connector oriented at a slant with reference to a machine longitudinal axis of the hand-held grinding machine,

FIG. 14 a further variant of the hand-held grinding machine according to FIGS. 12, 13, having a dust discharge connector at a greater angle than in the case of the hand-held grinding machine according to FIG. 13,

FIG. 15 a bottom view of the hand-held grinding machine according to the above figures, as well as an energy storage device interface for installation on the same,

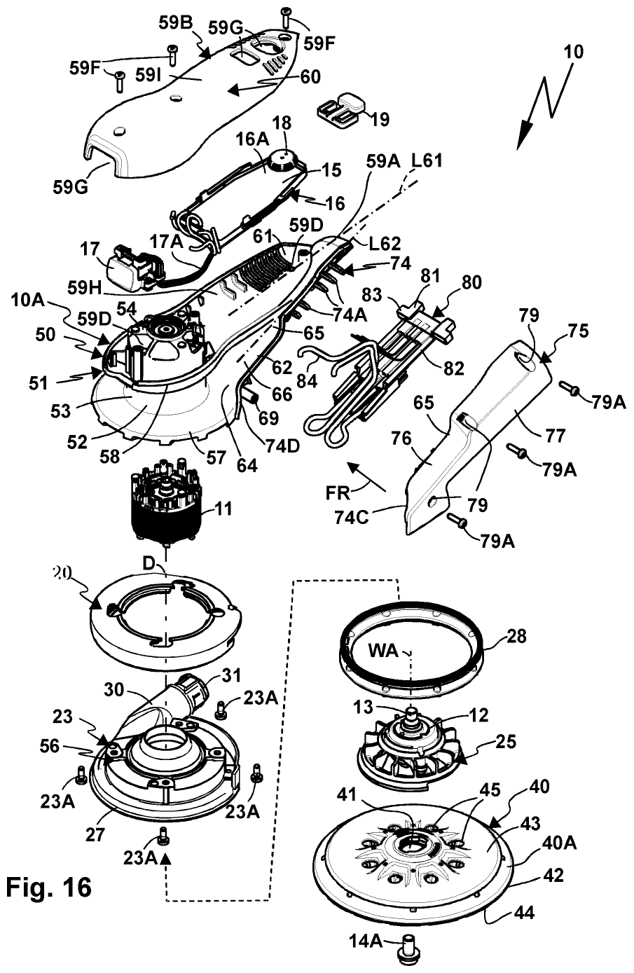

FIG. 16 an exploded representation of the hand-held grinding machine according to the above figures, at a slant from above,

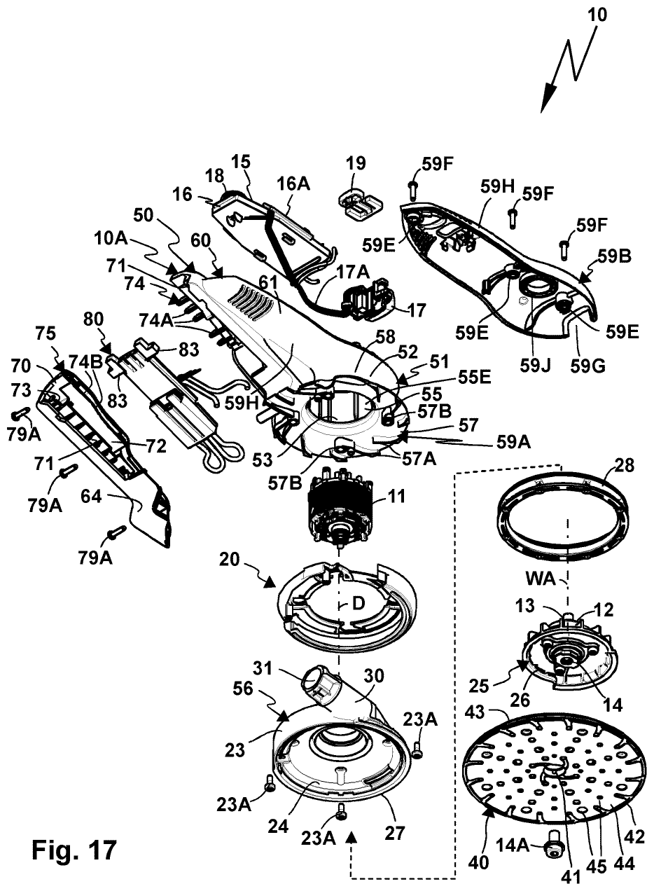

FIG. 17 the exploded representation corresponding to FIG. 16, but at a slant from below,

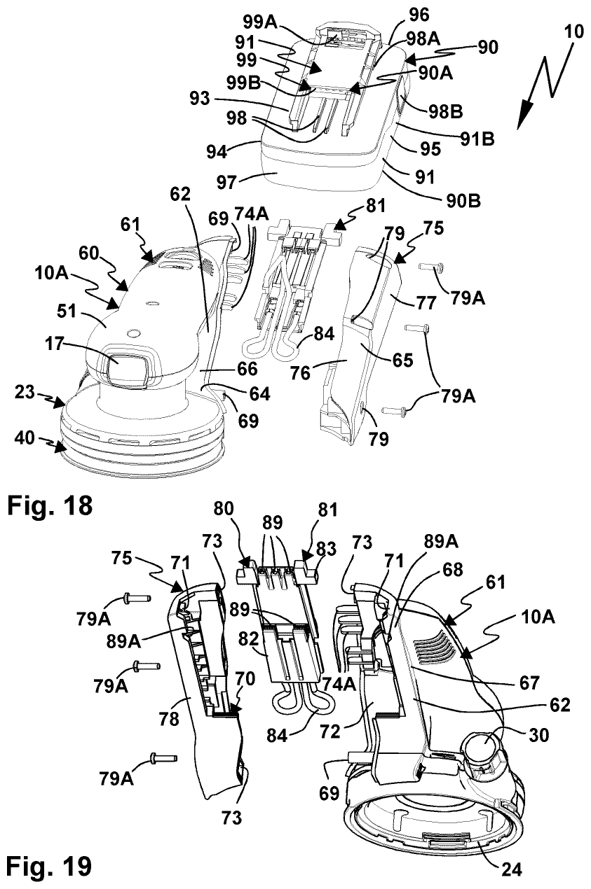

FIG. 18 the hand-held grinding machine according to the above figures, in a partially assembled state, at a slant from above, from the top,

FIG. 19 the partially assembled hand-held grinding machine according to FIG. 18 at a slant from the rear, from below,

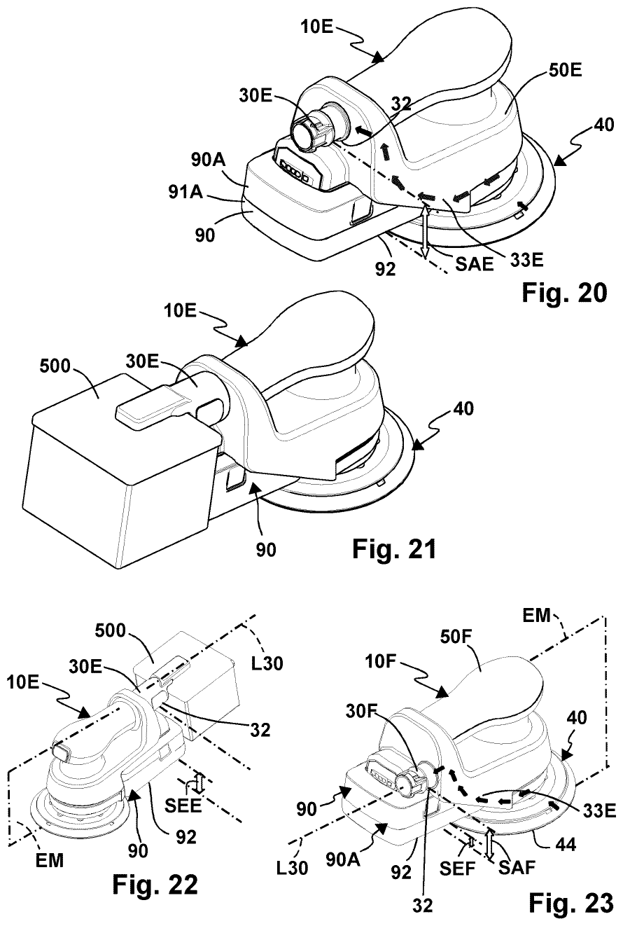

FIG. 20 a further hand-held grinding machine at a slant from the rear, from above, having an energy storage device interface below its dust discharge connector,

FIG. 21 the hand-held grinding machine according to FIG. 20, having a dust collection container,

FIG. 22 hand-held grinding machine from FIG. 21 at a slant from the front, from the top, and

FIG. 23 a variant of the hand-held grinding machine of FIGS. 20 to 22, having an alternatively arranged dust discharge connector.

In the case of the hand-held grinding machines 10A, 10B, 10C, and 10D, as explained below, the same or similar components are provided with the same reference numbers. If the description, in each instance, relates to all the hand-held grinding machines 10A, 10B, 10C, and 10D, these are also referred to, in general, as a hand-held grinding machine 10.

The hand-held grinding machine 10 has a drive motor 11 that drives a tool shaft 13 having a tool holder 14, directly or optionally by way of a schematically indicated gear mechanism 12. A disk tool 40, for example a round disk tool 40A or a polygonal, in particular an approximately triangular disk tool 40B for machining a workpiece WST can be detachably fastened to the tool holder 14, wherein the disk tool 40 could also be firmly connected to the tool holder 14.

A controller 15, which is structured as a controller module 16, for example, serves for controlling the drive motor 11. The controller module 16 comprises a circuit board 16A, for example. The switching element 17, which can be operated by an operator, serves for turning the drive motor 11 on and off. Using a further speed of rotation switching element 18, for example, a speed of rotation of the drive motor 11 can be set by an operator. An electrical function of the hand-held grinding machine 10 can be set using a switching element 19, for example.

A support element 20 is arranged on a suction hood 30. For example, the support element 20 has a ring-shaped support 21. The support element 20 is arranged between a machine housing 50 of the hand-held grinding machine 10 and a suction hood 23. The suction hood 23 forms a cover 23A for the disk tool 40.

A bearing body 25 is arranged for bearing the tool shaft 13 so that it can rotate in an interior of the suction hood 23, which forms a suction space 24.

The tool holder 14 is arranged on the tool shaft 13. The tool shaft 13 is connected, so as to rotate, to a power take-off of the drive motor 11 or a power take-off of the gear mechanism 12 that is driven by drive motor 11, in the finished, assembled state of the hand-held grinding machine 10.

The gear mechanism 12 is arranged between the drive motor 11 and the tool holder 14, and can be provided, for example, on the bearing body 25. For example, the gear mechanism 12 can be formed by an eccentric bearing or comprise an eccentric bearing. It is also possible that the bearing body 25 of the tool shaft 13 is only mounted so as to rotate, i.e., no gear mechanism 12 is present.

The tool holder 14 projects into a preferably hood-shaped interior 26 of the bearing body 25 and/or is arranged in the interior 26.

A disk tool 40, for example a grinding tool or a polishing tool, can be detachably fastened to the tool holder 14. The disk tool 40 is, for example, a round disk tool 40A or a polygonal, in particular a triangular disk tool 40B.

For example, bayonet connection means that can be brought into engagement with one another can be provided on the tool holder 14 and on a fastening interface 41 of the disk tool 40. In the case of the exemplary embodiment, however, a screw connection is provided, in particular using a fastening element 14A. The fastening element 14A comprises, for example, a screw that can be inserted through a passage opening of the fastening interface 41 and screwed into a screw holder of the tool holder 14A. The fastening interface 41 and the tool holder 14 furthermore have rotary entrainment contours for rotary entrainment of the disk tool 40 by the tool holder 14.

The hand-held grinding machine 10 has a dust discharge connector 30 for discharge of dust-charged air P from the suction space 24. The dust discharge connector 30 is connected, in terms of flow, with the suction space 24.

The dust discharge connector 30 is arranged on the suction hood 23, for example.

The dust discharge connector 30 has a connecting piece 31, for example, which is arranged on an outside of the suction hood 23 and suitable for connecting a suction hose 200 or dust collection containers 300 or 400. Optionally, the dust collection containers 300 or 400 can be arranged on the hand-held grinding machines 10A, 10B, 10C, 10D.

The disk tool 40 is essentially accommodated in the suction space 24 when the tool holder 14 is mounted in place.

A ring-shaped sealing element 28 is arranged on an outside circumference 27 of the suction hood 23. The sealing element 28 lies on an outside circumference 42 of the disk tool 40, for example, or opposite this circumference, so that a machine side 43 of the disk tool 40 is essentially accommodated in the suction space 24, in a sealed manner.

On opposite sides, the disk tool 40 has the machine side 43 as well as a machining face 44 for machining a workpiece W. The machining face 44 can comprise an adhesion means for attaching an abrasive disk or other abrasive material, for example. It is also possible that the machining face 44 directly comprises an abrasive material or polishing agent, which is firmly connected to a basic body of the disk tool 40 or formed by it.

The machining face 44 extends in a plane E44. The plane 44 extends, for example, along a planar surface of the workpiece W.

Through-flow openings 45 extend between the machining face 44 and the machine side 43, through which openings the dust-charged air P can flow from the machining face 44 to the machine side 43, wherein the air P flows in by way of in-flow openings of the through-flow openings 45 that are arranged on the machining face 44, and flows out of the through-flow openings 45 into the suction space 46.

The machine housing 50 has a drive portion 51 as well as a handle section 60.

The drive portion 51 comprises a motor housing 52 for holding the drive motor 11. The motor housing 52 comprises an approximately cylindrical peripheral wall 53 as well as a cover wall 54, which, in total, delimit a motor-accommodating space 55 for accommodating the drive motor 11.

The motor-accommodating space 55 is configured in the manner of an accommodation cylinder or accommodation pot, so that drive motor 11 accommodated in the motor-accommodating space 55 is supported on the peripheral wall 53 with its outside circumference or circumferentially, and also on the cover wall 54, at the end face or with an end face that faces away from the tool holder 14.

The motor-accommodating space 55 is closed off on opposite sides by means of the cover wall 54, on the one hand, and, in the assembled state of the hand-held grinding machine 10, on the other hand, by means of a lid 56. In the present case, the lid 56 is formed by the suction hood 23, i.e., its hood body.

The lid 56 serves for closing off an installation opening 55E, through which the motor-accommodating space 50 is accessible. For example, the drive motor 11 can be inserted into the motor-accommodating space 55 through the installation opening 55E. The lid 56 closes off the installation opening 55E. At this point, it should be noted that the installation opening 55E advantageously makes it possible for an entire drive train, as a whole, comprising the drive motor 11 as well as additional drive components, for example the gear mechanism 12 and/or the tool shaft 13 and/or the bearing body 25, to be inserted or to be insertable through the installation opening 55E, into the motor-accommodating space 55. Then the installation opening 55E is closed off using the lid 56. The installation of the drive motor 11 as well as components connected to it, into the motor-accommodating space 55, is therefore structured to be very simple.

It is advantageous that the lid 56 holds the drive motor 11 in the motor-accommodating space 55. The drive motor 11 is held between the cover wall 54 and the lid 56, for example, in the manner of a sandwich, when it is arranged in the motor-accommodating space 55.

The support element 20 is held between the suction hood 23 and the machine housing 50 in the manner of a sandwich. For example, the support element 20 supports itself on a support wall 57 of the machine housing 50.

The support wall 57 extends around a plug-in opening of the motor-accommodating space 55, for example, through which opening the drive motor 11 can be inserted into the motor-accommodating space 55.

The support wall 57 projects radially outward with reference to an axis of rotation D of the drive motor 11, for example. The axis of rotation D of the drive motor 11 forms a tool axis WA, for example, around which the tool shaft 13 and thereby the disk tool 40 are driven to rotate. However, it is also possible that the tool axis WA and the axis of rotation D are at an angle to one another or parallel to one another, for example if the gear mechanism 12 is configured and provided for converting a rotational movement of the drive motor 11 into an oscillating drive movement of the tool holder 14 or tool shaft 13.

The support wall 57 projects beyond the motor housing 51, for example in the manner of a collar or a flange, radially outward with reference to the tool axis WA.

Ribs 57A can be arranged on the support wall 57, which ribs delimit air channels for cooling air to cool the drive motor 11, for example.

Furthermore, screw holders 57B for screws 23A are preferably arranged on the support wall 57, with which the lid 56 that closes off the motor-accommodating space 55, for example the suction hood 23, can be screwed onto the machine housing 50.

The peripheral wall 53 of the motor housing 51 can advantageously be surrounded, entirely or in certain sections, by an outside circumference wall 58.

For example, an interstice 58Z can be present between the peripheral wall 53 and the outside circumference wall 58, which interstice is suitable for holding electrical lines 84 between the controller module 16 and the energy storage device interface 80, for example. Furthermore, the outside circumference wall 58 can be configured in the manner of a collar that projects away from the peripheral wall 53 of the motor housing 52. The outside circumference wall 58 can contribute to reinforcing the peripheral wall 53.

The handle section 60 comprises a handle body 61 that projects away from the machine housing 50, transverse to the tool axis WA. The handle body 61 can be grasped by the operator hand.

A longitudinal axis L61 of the handle body 61 preferably runs at a right angle to the tool axis WA, but can also have a small angle of less than 30°, in particular, preferably less than 20° or less than 10° relative to the tool axis WA. It is preferred if the longitudinal axis L61 of the handle body 61 has an incline of less than 10° with reference to the machining face 44. If the longitudinal axis L61 has an incline with reference to the machining face 44, a longitudinal end region of the handle body 61 that is farther away from the motor housing 52 is preferably arranged farther away from the plane E44 in which the machining face 44 is arranged than a longitudinal end region of the handle body 61 that is connected to the motor housing 52.

Now it would fundamentally be possible that an electrical energy storage device 90 is held directly on the handle body 61, for example if an energy storage device interface in the manner of the energy storage device interface 80 explained below is arranged on the handle body 61. Such an energy storage device interface could be provided on a free end region of the handle body 61, for example, which region faces away from the motor housing 52.

In the present case, however, an embodiment is selected in which an energy storage device interface 80 is arranged on a connection protrusion 62 that projects away from the motor housing 52.

Both could also easily be provided, for example that an energy storage device interface 80 is arranged on the connection protrusion 62 and furthermore on the handle body 61.

The connection protrusion 62 lies opposite the handle body 61, so that a distance is present between the connection protrusion 62 and the handle body 61, which distance is configured, in the present case, as a reach-through opening 63 or comprises a reach-through opening 63, so that an operator can grasp the handle body 61 through the reach-through opening 63. The reach-through opening 63

The connection protrusion 62 is closer to the machining face 44 than the handle body 61.

The connection protrusion 62 projects, like the handle body 61, from the drive portion 61, transverse to the tool axis WA, in the direction of a machine longitudinal axis LM.

The machine longitudinal axis LM runs through a machine longitudinal center plane EM of the hand-held grinding machine 10 or of the machine housing 50, for example. The machine longitudinal center plane EM is at an angle relative to the machining face 44, for example at a right angle.

It is advantageous if the axis of rotation D of the drive motor 11 and/or the tool axis WA is/are parallel to the machine longitudinal center plane EM.

An operator who grasps the hand-held grinding machine 10 by the handle body 61 can guide the hand-held grinding machine 10 forward in a working direction AR, for example, along a workpiece, which direction is parallel or essentially parallel to the machine longitudinal axis LM.

The longitudinal axis L61 of the handle body 61 is at a right angle, for example, to the tool axis WA.

A longitudinal axis L62 of the connection protrusion 62 is inclined relative to the tool axis WA, for example at an angle of approximately 15-30°.

One longitudinal end of the connection protrusion 62 is connected to the motor housing 52 or the drive portion 51; another longitudinal end of the connection protrusion 62, opposite to the first, could form a free end in an embodiment of the hand-held grinding machine 10 or the invention, not shown, but is connected, in the case of the hand-held grinding machine 10, to a longitudinal end of the handle body 61 that faces away from the drive portion 51 or the motor housing 52, so that the handle body 61 and the connection protrusion 62 form a configuration that delimits the reach-through opening 63 and/or are supported on one another at their end regions that face away from the drive portion 51. Thereby the handle body 61 and the connection protrusion 62 reinforce one another or support one another.

It is advantageous if the handle body 61 and the connection protrusion 62 in total have a U-shaped or V-shaped form transverse to the machine longitudinal axis LM.

Together with the motor housing 52 that is closed off by means of the peripheral wall 53 on the circumference, the handle body 61 and the connection protrusion 62 form a rigid machine housing 50 that is optimally suited for work operation of the hand-held grinding machine. The machine housing 50 is furthermore robust against impacts as a result of this rigid configuration, in particular if the hand-held grinding machine 10 falls onto a subsurface.

The energy storage device interface 80 is arranged on the side of the connection protrusion 62, on a side facing the machining face 44. The energy storage device interface 80 comprises an energy storage device holding body 81 for detachably holding the energy storage device 90 and for producing electrical connections to the energy storage device 90.

The energy storage device holding body 81 is accommodated in a holding body holder 70. The energy storage device holding body 81 is held, with shape fit, in the holding body holder 70.

The holding body holder 70 comprises side walls 71 on which holding grooves or rear engagement contours for holding longitudinal sides 82 of the energy storage device holding body 81 are present. Furthermore, holding protrusions 83 are arranged on the longitudinal sides 82 of the energy storage device holding body 81, which protrusions engage into holding accommodations 73 of the holding body holder 70. The holding accommodations 73 are arranged on the side walls 71. A machine side of the energy storage device holding body 81 that extends between the longitudinal sides 82 supports itself on a bottom of the holding body holder 70.

It is advantageous if the holding protrusions 83 are components of attenuators or attenuation elements, for example they are elastically resilient. As a result, the energy storage device holding body 81 is held on the machine housing 50 in an elastically attenuated manner, so that vibrations of the drive motor 11, for example, are transferred to the energy storage device 90 and/or the connection contacts 89 and/or 99 to a lesser degree.

The holding body holder 70 can be closed off by means of a holder closure body 75. The holder closure body 75 forms a housing part of the machine housing 50. The holder closure body 75 has a longitudinal expanse that is oriented in the direction of the machine longitudinal axis LM. Consequently, the holder closure body 75 has an elongated shape.

The holder closure body 75 can be joined onto the connection protrusion 62 in a joining direction FR transverse to the machine longitudinal axis LM, and screwed onto the protrusion.

The holder closure body 75 and the connection protrusion 62 then have cover walls 76, 66 as well as bottom walls 78, 68 that align with one another. The cover walls 76, 66 lie opposite the handle body 61. The bottom walls 68, 78 and the cover walls 66, 76 are arranged on sides of the connection protrusion 62 and of the holder closure body 75 that face away from one another. The energy storage device interface 80, in particular the energy storage device holding body 81, is arranged on the bottom walls 78, 68.

Screw domes 69 are arranged on the connection protrusion 62, which domes align with screw holders 79 when the holder closure body 75 is arranged on the connection protrusion 62. Then screws 79A can be screwed into the screw domes 69 through the screw holders 79. As a result, the holder closure body 75 is held in place on the connection protrusion 62.

Furthermore, the holder closure body 75 is held on the connection protrusion 62 by means of a plug-in arrangement 74.

The plug-in arrangement 74 comprises plug-in protrusions 74A that engage into plug-in sockets 74B. For example, the plug-in sockets 74B are arranged on the holder closure body 75, and the plug-in protrusions 74A are arranged on the connection protrusion 62, wherein the reverse configuration is also possible, that plug-in protrusions are provided on the holder closure body 75, which engage into plug-in sockets on the connection protrusion 62. The plug-in protrusions 74A and the plug-in sockets 74B are arranged next to one another in a serial arrangement, in particular along a serial axis. This serial axis runs parallel, for example, or at a small angle of less than 10° inclined relative to the longitudinal axis L62 of the connection protrusion 62.

It is preferred if the plug-in sockets 74B are configured between the cover wall 76 and a bottom wall that forms the bottom 72 of the holding body holder 70.

When the holder closure body 75 is held on the connection protrusion 62, end faces of wall sections of the holder closure body 75 engage, in the manner of plug-in protrusions 74C, into step contours or steps 74D on end faces of wall sections of the connection protrusions 62, and thereby a further plug-in connections of the plug-in arrangement 74 is implemented.

It is advantageous, in particular, that the plug-in arrangement 74 is arranged in the region of the holding body holder 70 and thereby of the energy storage device interface 80, to hold the energy storage device 90, and thereby ensures a firm hold of the holder closure body 75 on the connection protrusion 62 as well as of the energy storage device holding body 81 in the holding body holder 70.

The connection protrusion 62 and the holder closure body 75 have side walls 67, 77 on opposite side or on sides that face away from one another.

Steps 64, 65 contribute to further reinforcement of the machine housing 11, which steps are provided on the connection protrusion 62 as well as on the holder closure body 75. The steps 64, 65 are arranged in the region of the reach-through opening 63. The step 64 is arranged close to the motor housing 52, and the step 65 is arranged on the end region of the connection protrusion 62 as well as of the holder closure body 75 away from the motor housing 52, where the handle body 61 is connected to the connection protrusion 61.

The motor housing 52 and the connection protrusion 62 are provided or arranged in one piece on a basic housing body 59A of the machine housing 50. This measure advantageously contributes to the rigidity of the machine housing 50.

The basic housing body 59A is closed off by means of a housing lid 59B, wherein an accommodation space 59C is formed between the basic housing body 59A and the housing lid 59B, in which space the controller 15, in particular the controller module 16, is arranged.

The handle body 61 is formed, in part, by the housing lid 59B, namely by means of a handle section 59I of the housing lid 59B, which closes off a handle section 59H of the basic housing body 59A that projects away from the motor housing 52. The handle body 61 is in two parts and consists of the handle sections 59H and 591.

The housing lid 59B is screwed onto the basic housing body 59A, for which purpose screws 59F, for example, are inserted through pass-through openings 59E of the housing lid 59B and screwed into screw holders 59D on the basic housing body 59A.

The basic concept with the energy storage device interface 80 on the connection protrusion 62 also allows advantageous laying of electrical lines, for example the lines 84.

It is advantageous if passage openings 59G are provided on the housing lid 59B for the switching elements 17, 18 and 19, through which openings the activation parts of the aforementioned switching elements 17-19 project beyond an outside of the housing lid 59B and thereby an outer surface of the machine housing 50, so that they can be activated by an operator. The switching element 18 and an electrical component of the switching element 19 are arranged directly on the circuit board 16A or the controller module 16, for example. In the drawing, the switching element 19, for example, is explicitly indicated only with its activation component, which interacts with an electrical component, for example electrical contacts, directly on the controller module 16. The switching element 17 is connected to the controller module 16 using a short electrical line 17A, wherein the line 17A is conducted past the side of the lid 56 of the motor housing 52, for example.

At this point it should be mentioned that the housing lid 59B has a support surface or support contour 59J, which is supported on the cover wall 54 of the motor housing 52. This measure also contributes to reinforcement and a stable construction of the machine housing 50.

The energy storage device interface 80 has shape-fit contours 88 for engagement of shape-fit contours 98 of a connection interface 90A of the energy storage device 90, which are arranged on the top side 93 of the energy storage device housing 91, for example. The shape-fit contours 88 are arranged, at least in part, on the energy storage device holding body 81.

The shape-fit contours 88, 98 comprise longitudinal grooves, for example, which extend along a plug-in direction, along which the energy storage device 90 can be plugged into the energy storage device interface 80 with its connection interface 90A.

In the plugged-in state, the energy storage device 90 can be locked onto the energy storage device interface 80 using engagement means. The engagement means comprise engagement sockets 88A on the energy storage device interface 80, for example, into which engagement protrusions 98A of the connection interface 90A can engage. The engagement protrusions 98A can be brought out of engagement with the engagement sockets 88A by means of at least one activation element 98B, for example at least one pressure activation element on the longitudinal side 94 and/or 95.

Furthermore, the connection interface 90A has connection contacts 99, in particular plug-in contacts, for example electrical power supply contacts 99A, data contacts 99B and the like, for electrical contacting of connection contacts 89, power supply contacts 89A that correspond to the contacts 99A, 99B, and data contacts 89B of the energy storage device interface 80, which are also preferably configured as plug-in contacts. The power supply contacts 99A have a length distance from the data contacts 99B, because the power supply contacts 89A and the data contacts 89B also have from one another.

It is advantageous if the power supply contacts 89A and the data contacts 89B are arranged on the energy storage device holding body 81.

Thereby the energy storage devices 90, when they are connected to the energy storage device interface 80, can supply the controller 15 and the drive motor 11 with power.

The energy storage device 90 can be attached to the energy storage device interfaces 80 of the hand-held grinding machines 10A, 10B, 10C and 10D. The energy storage device 90 contains storage cells SP, for example battery cells, which can make electrical energy available and are rechargeable.

The energy storage device 90 is presented in the following, in a variant 90A and a variant 90B, wherein an electrical capacitance and performance capacity of the variant 90A is greater than that of the energy storage device 90B, which has fewer storage cells SP than the energy storage device 90A. The energy storage device 90A and 90B can be optionally turned on the hand-held grinding machines 10A, 10B, 10C and 10D.

As an example, three layers of storage cells SP are shown in the energy storage device 90A, and two layers of storage cells SP are shown in the energy storage device 90A, wherein both in the case of the energy storage device 90A and in the case of the energy storage device 90B, more or fewer layers of storage cells SP can be present, which are arranged one on top of the other. For example, therefore, three or more storage cells SP are arranged in a direction perpendicular to the plane E44 in the case of the energy storage device 90A, while in the case of the energy storage device 90B, only a single storage cell SP or maximally two storage cells SP are arranged perpendicular to the plane E44, one on top of the other.

An energy storage device housing 91 of the energy storage device 90 accordingly has variants 91A and 91B, wherein the energy storage device housing 91A holds more storage cells SP than the energy storage device housing 91B. For example, for this purpose, distances between an underside 92 and a top side 93 of the energy storage device housing 91A and 91B are different. For reasons of simplification, both energy storage device housings 91A, 91B will be described as an energy storage device housing 91 hereinafter.

Longitudinal sides 94, 95 extend between the undersides 92 and top sides 93 of the energy storage device housing 91, wherein the longitudinal side 94 faces the machine housing 50, and the longitudinal side 95 forms a free longitudinal side when the energy storage device 90 is fastened to the machine housing 50. Furthermore, a front side 97 as well as a rear side 96 extend between the top side 93 and the underside 92, wherein the rear side 96 is farther removed from the disk tool 40, in the state of the energy storage device 90 when it is mounted on the energy storage device interface 80, than the front side 97, which is arranged closer to the disk tool 40. This results in an advantageous position of the center of gravity.

The suction hose 200 and the dust collection containers 300, 400 have connection elements 201, 301 and 401, for example tubular or sleeve-shaped connection elements, with which the suction hose 200 or the dust collection container 300, 400 can be connected to the connecting piece 31.

The dust discharge connector 30, in particular the connecting piece 31, extends along a longitudinal expanse axis L30. The connecting piece 31 delimits a flow channel 33 that extends along the longitudinal expanse axis L30.

Therefore the connection element 201, 301 and 401, in each instance, also extends along the longitudinal expanse axis L30 when it is plugged onto the connecting piece 31. A section of the suction hose 200, which is connected to the connection element 201, also has an orientation or longitudinal expanse that is oriented parallel to the longitudinal expanse axis L30 or at a small angle to it, for example of maximally 15°, in particular maximally 10° or particularly preferably maximally 5°. Thereby the suction hose 200 has an orientation in the vicinity of the dust discharge connector 30 that corresponds to the longitudinal expanse axis L30.

The connection elements 201, 301 and 401 are oriented toward the rear in the working direction AR.

The connection elements 301 and 401 are arranged on front sides 307 and 407 of the dust collection containers 300 and 400. At rear sides 306 as well as 406 that are opposite to them, the dust collection containers 300 as well as 400 advantageously have removal openings 308 and 408 for removing dust that has collected in the interiors of the dust collection containers 300 and 400. Longitudinal sides 304 as well as 404, which face the machine housing 50, extend between the front sides 307 as well as 407, as do longitudinal sides 305 and 405, which face away from the machine housing 50, when the dust collection container 300 or 400, in each instance, is fastened to the dust discharge connector 30. An underside 302, 402 that is closer to the machining face 44 extends between the longitudinal sides 304 and 305 as well as 404 and 405, as does a top side 303 as well as 403 of a dust collection container 300 or 400, in each instance, that is farther away from the machining face 44, when the container is arranged on the dust discharge connector 30.

The energy storage device interface 80 has an advantageous position on the machine housing 50, with reference to the machining face 44 and with reference to the dust discharge connector 30, as will become clear below:

The energy storage device interface 80 is arranged on the machine housing 50 in such a manner that the energy storage device 90 is closer to the machining face 44 than the dust discharge connector 30 is. The undersides 92 of the energy storage devices 90A, 90B have minimal energy storage device distances SEA, SEB perpendicular to the plane E44 in which the machining face 44 is arranged, which distances are smaller than a dust discharge connector distance SA of the dust discharge connector 30 with reference to this plane E44 or the machining face 44. Thereby the energy storage device 90A, 90B, in each instance, comes very close to the machining face 44, and this results in an advantageous location of the center of gravity of the hand-held grinding machine 10A, 10B.

In FIG. 9, an alternative arrangement of a dust discharge connector 30B that is slightly farther away from the machining face 44 is indicated, which has a dust discharge connector distance SAB from the machining face 44, perpendicular to a plane in which the machining face 44 runs.

Furthermore, the energy storage device interface 80 is not symmetrical to the machine longitudinal axis LM or machine longitudinal center plane EM in which the machine longitudinal axis LM extends, but rather asymmetrical.

As a result, an energy storage device longitudinal center plane EE, for example, has a transverse distance QE from the machine longitudinal center plane EM.

This transverse distance QE is actually so great, in this regard, that the energy storage device 90 is arranged almost entirely on the side next to the machine longitudinal center plane EM; see FIGS. 9 and 11, in particular, in this regard.

The dust discharge connector 30 or 30B is also not arranged symmetrically centered in the machine longitudinal center plane EM, but rather has a transverse distance QS from it.

A dust discharge connector longitudinal center plane E3 of the two dust discharge connectors 30 and 30B, parallel to the machine longitudinal center plane EM, is arranged in the transverse distance QS from the machine longitudinal center plane EM.

As a result, a configuration is obtained in which the dust discharge connector 30 and the energy storage device 90 are arranged on opposite sides of the machine longitudinal center plane EM.

However, the energy storage device 90 and the dust discharge connector 30 do not project to the side beyond the disk tool 40, with reference to the machine longitudinal axis LM or the machine longitudinal center plane EM; this can be seen in FIGS. 8-11.

The disk tool 40A, 40B is arranged within a corridor KO with reference to the machine longitudinal axis LM and/or the machine longitudinal center plane EM, which corridor is delimited by lateral corridor planes KL and KR, beyond which the disk tool 40A or 40B does not project transverse to the machine longitudinal axis LM or machine longitudinal center plane EM. The planes KL and KR are parallel to the machine longitudinal center plane EM and/or perpendicular to the machining face 44 or the plane E44 in which the machining face 44 extends. The energy storage device 90 and the dust discharge connector 30 are situated between the planes KL and KR.

However, it is also possible that a disk tool 40C, in particular a round disk tool, which has a smaller diameter in comparison with the disk tool 40A, is arranged on the hand-held grinding machine 10 (FIG. 9). In this case, the corridor planes KL and KR are less apart from one another, and the corridor KO is therefore narrower.

It can be seen in FIG. 9, for example, that the energy storage device 90B, with its longitudinal side 95, projects beyond the corridor plane KL at a distance Q1. The longitudinal side 95 extends, for example, in a plane K95 that is parallel to the machine longitudinal center plane EM and has the distance Q1 from the corridor plane KL.

Although the energy storage device 90B is arranged asymmetrically with reference to the machine longitudinal center plane EM, the distance Q1 is small, for example maximally 15 mm, in particular maximally 10 mm, preferably maximally 5 mm, or, to state it differently, the distance Q1 is maximally 15%, in particular maximally 10%, particularly preferably maximally 8% of the diameter of the disk tool 40C.

An outside 35 of the dust discharge connector 30, which faces away from the machine housing 50, extends in a plane K35 that is parallel to the machine longitudinal center plane EM. The dust discharge connector 30, in particular its side 35, does not project beyond the corridor plane KR.

The longitudinal side 405 of the dust collection container 400 extends in a plane K405 that is parallel to the machine longitudinal center plane EM. The dust collection container 400 projects beyond the disk tool 40C and/or the corridor plane KR with its longitudinal side 405 that faces away from the machine housing 50, with a transverse distance Q2. Consequently, therefore, the transverse distance Q2 is present between the corridor plane KR and the plane K405. The transverse distance Q2 is, for example, maximally 20%, in particular maximally 15%, preferably maximally 10% of the diameter of the disk tool 40C.

The dust discharge channel or flow channel 33 gives the suction hose 200 a direction that corresponds to its longitudinal expanse axis L30. In FIG. 12, it can be seen that accordingly, the suction hose 200 arranged on the dust discharge connector 30 is also oriented close to the dust discharge connector 30 in its in-flow region, in the direction of the longitudinal expanse axis L30, and thereby within the corridor between the planes KL and KR.

If, however, longitudinal expanse axes L30 of flow channels of dust discharge connectors 30C and 30D run at an angle relative to the machine longitudinal center plane EM or machine longitudinal axis LM, namely have an angle of W1 or W2 relative to it, the section of the suction hose 200 that is connected to the dust discharge connector 30C or 30D, in each instance, projects beyond one of the corridor planes, namely the corridor plane KR. Nevertheless, even in this situation the asymmetrical arrangement of the energy storage device 90 with reference to the machine longitudinal center plane EM has an advantage, namely that a large space is available for the suction hose 201 on the side of the machine longitudinal center plane EM that faces away from the energy storage device 90.

Hand-held grinding machines 10E (FIGS. 20-22) and 10F (FIG. 23) have machine housings 50E, 50F that are essentially the same as the machine housings 50, but have energy storage device interfaces and dust discharge connectors 30E as well as 30F that are arranged differently. The hand-held grinding machines 10E and 10F also have drive motors (which cannot be seen in the drawing) in the manner of the drive motor 11, with which motors disk tools 40 are driven or can be driven.

In the case of the hand-held grinding machine 10E, the energy storage device interface is arranged in such a manner that the energy storage device 90 arranged on the machine housing 50E, for example in the variant 90A, is arranged completely below the dust discharge connector 30E. An underside 32 of the dust discharge connector 30E has a dust discharge connector distance SAE, and an underside 92 of the energy storage device 90 has an energy storage device distance SEE with reference to a plane in which the machining face 44 runs, wherein the dust discharge connector distance SAE is clearly greater than the energy storage device distance SEE. The dust discharge connector 30E is arranged completely above the top side 93 of the energy storage device 90.

In order to convey dust-laden air (indicated with black arrows) away from the disk tool 40, in the direction of the dust discharge connector 30E, the hand-held grinding machine 10E has a flow channel 33E that runs from the disk tool 40 to the dust discharge connector 30E, through the machine housing 50E.

In the case of the hand-held grinding machine 10F, as well, a flow channel is present that runs through its machine housing 50F, namely a flow channel 33E. The flow channel 33E empties into in a dust discharge connector 30F, which is arranged, at least essentially, above the top side 93 of the energy storage device 90 arranged on the energy storage device interface of the hand-held grinding machine 10F. An underside 32 of the dust discharge connector 30F has a dust discharge connector distance SAF, and an underside 92 of the energy storage device 90 has an energy storage device distance SEF, with reference to a plane in which the machining face 44 runs, wherein the dust discharge connector distance SAF is greater than the energy storage device distance SEF.

In the case of the hand-held grinding machines 10E and 10F, it is advantageously provided that an energy storage device longitudinal center plane of the energy storage device 90, in each instance, which is not shown in the drawing, has a transverse distance from the machine longitudinal center plane EM. This can be seen by looking at FIGS. 21 and 22 together.

While the dust discharge connector 30E is arranged symmetrically with reference to the machine longitudinal center plane EM, the dust discharge connector 30F is arranged asymmetrically relative to it; see FIG. 23 in this regard.

Variants of the energy storage device interface 80 are indicated schematically in FIGS. 8 and 9. For example, an energy storage device interface 80E can have energy storage device interface connectors 80E1 and 80E2, on which energy storage devices 90E1 and 90E2 can be detachably mounted. The energy storage device interface connectors 80E1 and 80E2 are both arranged asymmetrically to the side of the machine longitudinal center plane EM, for example, next to one another, so that the energy storage device interface 80E is completely asymmetrical with reference to the machine longitudinal center plane EM. However, it is also possible, for example, that the energy storage device interface connector 80E1 is completely to the side, next to the machine longitudinal center plane EM, while the energy storage device interface connector 80E2 partially has the machine longitudinal center plane EM passing through it. For example, the machine longitudinal center plane EM can run transverse in the center or approximately transverse in the center with reference to the energy storage device interface connector 80E2.

Alternatively, an embodiment in which the energy storage device interface connectors in a series direction, one behind the other, along a line that runs approximately parallel to the machine longitudinal center plane EM or has a slightly slanted incline relative to it, for example in the manner of the dust collection container 300 according to FIG. 10, is also possible. Such an embodiment is indicated in

FIG. 8, with energy storage device interface connectors 80F1 and 80F2 of an energy storage device interface 80F, to which the energy storage devices 90E1 and 90E2 can be connected, for example.

Combinations of the two aforementioned embodiments are also easily possible, i.e., for example that a combination of the energy storage device interface connectors 80F1 and 80E2 is provided, so that a stepped arrangement of energy storage device interface connectors is implemented.

1. A hand-held grinding machine that has a disk tool having a machining face for machining a workpiece, a machine housing in which a drive motor for driving a tool holder is arranged, on which holder the disk tool is arranged, a dust discharge connector for conducting away dust that occurs during machining of the workpiece by the disk tool, and an energy storage device interface for detachably connecting an electrical energy storage device for supplying electrical energy to the hand-held grinding machine, in particular to the drive motor, using a connection interface of the energy storage device, wherein the electrical energy storage device has an energy storage device housing that extends along an energy storage device longitudinal center plane, wherein the machine housing has a machine longitudinal center plane that runs, in particular, at a right angle transversely to the machining face, wherein the hand-held grinding machine has a handle portion at which the hand-held grinding machine can be grasped by an operator and guide forward along the workpiece, in a working direction parallel to the machine longitudinal center plane, wherein the energy storage device interface of the hand-held grinding machine, with reference to the machine longitudinal center plane and/or the connection interface of the energy storage device with reference to the energy storage device longitudinal center plane is/are arranged in such a manner that the energy storage device longitudinal center plane has a transverse distance from the machine longitudinal center plane when the energy storage device is held on the energy storage device interface, and wherein only a single energy storage device can be arranged on the energy storage device interface.

2. The hand-held grinding machine according to claim 1, an underside of the dust discharge connector, which underside faces the machining face, has a dust discharge connector distance from a plane that contains the machining face, which distance is greater than a minimum energy storage device distance of an underside of the energy storage device mounted on the energy storage device interface, which underside faces the machining face, from the plane.

3. The hand-held grinding machine according to claim 1, wherein the energy storage device interface is arranged asymmetrically with reference to the machine longitudinal center plane and/or entirely or by at least 80% of its transverse expanse that extends transversely to the machine longitudinal center plane, to the side, next to the machine longitudinal center plane.

4-5. (canceled)

6. The hand-held grinding machine according to claim 1, wherein the energy storage device interface forms the only energy storage device interface of the hand-held grinding machine.

7. The hand-held grinding machine according to claim 1, wherein the hand-held grinding machine is supplied with electrical energy by only a single energy storage device or wherein the energy storage device interface has a first energy storage device interface connector and at least a second energy storage device interface connector for a first and at least a second energy storage device.

8. The hand-held grinding machine according to claim 1, wherein the energy storage device interface of the hand-held grinding machine is arranged between the tool holder or the disk tool when the disk tool is attached to the tool holder, and a longitudinal end region of the handle portion that faces away from the tool holder or the disk tool.

9. The hand-held grinding machine according to claim 1, wherein the energy storage device attached to the energy storage device interface does not project beyond a longitudinal end region of the handle portion that faces away from the tool holder or wherein the energy storage device attached to the energy storage device interface projects by maximally 50%, in particular maximally 30%, further preferably maximally 20% of its longitudinal length, which runs parallel to a distance between the tool holder and a longitudinal end region of the handle portion or of the machine housing, which distance faces away from the tool holder, beyond the longitudinal end region of the handle portion or of the machine housing.

10. The hand-held grinding machine according to claim 1, wherein the energy storage device does not project or projects only by maximally 30%, in particular maximally 20%, preferably maximally 10% of a longitudinal expanse of the machine housing, beyond the machine housing.

11. The hand-held grinding machine according to claim 1, wherein the energy storage device interface is arranged on a side of the machine housing that is oriented in the direction of the machining face, in particular of the handle portion of the machine housing, and/or on a side of the machine housing that has the tool holder, in particular in the region of the handle portion.

12. The hand-held grinding machine according to claim 1, wherein the energy storage device interface is arranged on a side of the machine housing that is oriented in the direction of the machining face, in particular of the handle portion of the machine housing.

13. The hand-held grinding machine according to claim 1, wherein the energy storage device longitudinal center plane as well as a center plane of the dust discharge connector that is perpendicular to the machining face and parallel to the machine longitudinal center plane are arranged on opposite sides of the machine longitudinal center plane.

14. The hand-held grinding machine according to claim 1, wherein the energy storage device distance is less in a longitudinal end region of the energy storage device that faces the machine housing of the hand-held grinding machine than in a longitudinal end region that faces away from the machine housing.

15-16. (canceled)

17. The hand-held grinding machine according to claim 1, wherein the disk tool is arranged in a suction space that is connected, in terms of flow, to the dust discharge channel, in particular one that is arranged on a suction hood.

18. The hand-held grinding machine according to claim 1, wherein the dust discharge connector is arranged on a suction hood that covers the disk tool, at least in part, and/or that a dust discharge channel that communicates with the dust discharge connector does not run through the machine housing.

19-21. (canceled)

22. The hand-held grinding machine according to claim 1, wherein the dust discharge connector has a connecting piece for connecting a suction hose or dust collection container or is formed by it.

23. The hand-held grinding machine according to claim 1, wherein the dust discharge connector defines a flow channel that extends along a longitudinal expanse axis that is parallel to the machine longitudinal center plane or has an angle, relative to the machine longitudinal center plane, of maximally 30°, in particular maximally 20°, particularly preferably maximally 15° or maximally 10°.

24. The hand-held grinding machine according to claim 1, wherein a total longitudinal expanse of the hand-held grinding machine, parallel to the machine longitudinal center plane, is maximally 2.5 times, in particular maximally twice as great as the longitudinal expanse of the energy storage device parallel to the machine longitudinal center plane.

25. The hand-held grinding machine according to claim 1, wherein the energy storage device has maximally five, preferably maximally four, preferably maximally three, in particular maximally two, particularly preferably maximally one storage cell with reference to a direction perpendicular to the plane in which the machining face is arranged.

26. The hand-held grinding machine according to claim 1, wherein the machine longitudinal center plane runs parallel to a tool axis of a tool shaft that is driven or can be driven by the drive motor, on which shaft the disk tool is arranged or can be arranged so as to be driven by the drive motor.

27. The hand-held grinding machine according to claim 1, wherein the disk tool can be driven to rotate with reference to the tool axis, by the drive motor, in particular using a gear mechanism, and/or can be driven to oscillate and/or can be driven with a hypercycloid rotational movement.
